(19) United States
(12) Patent Application Publication
(10) Pub. No.: US 2010/0072341 A1
(43) Pub. Date: Mar. 25, 2010

(54) Tool hanger

(76) Inventor: Jui-Chien Kao, Tali City (TW)

Correspondence Address: COOPER & DUNHAM, LLP, 30 Rockefeller Plaza, 20th Floor, NEW YORK, NY, 10112, US

(21) Appl. No.: 12/284,562

(22) Filed: Sep. 23, 2008

(51) Int. Cl. B42F 13/00

(52) U.S. Cl. 248/340

(57) ABSTRACT

A tool hanger has a rail and multiple hanging blocks. The rail is an elongated bar and has at least one hole. Each hanging block has a hanging body, an arm and a hook. The hanging body has a sliding slot being slidably mounted on the rail. The arm protrudes from the hanging body and has a cylinder. The hook is attached to the arm.

### BACKGROUND OF THE INVENTION

1. Field of the Invention

The present invention relates to a tool hanger, especially to a tool hanger being able to hang more tools and being made with less material.

2. Description of the Prior Art

A conventional tool hanger is used to hang and display socket wrench adapters or box-end wrenches and comprises a rail and multiple hanging blocks. The hanging blocks are slidably attached to the rail. Each hanging block has a cylinder or a hook for hanging a socket wrench adapter (“adapter”) or a box-end wrench (“wrench”).

A hanging block of the conventional tool hanger can only hang one specific kind of tool. To hang adapters and wrenches on the tool hanger, multiple different hangers in different kinds and sizes are necessary. However, arranging different tool hangers requires lot of material for production and increases cost for manufacturing the tool hanger. In addition, each hanging block of the conventional tool hanger can only hang one specific kind of tool is not versatile in use.

To overcome the shortcomings, the present invention provides a tool hanger to mitigate or obviate the aforementioned problems.

### SUMMARY OF THE INVENTION

The main objective of the invention is to provide a tool hanger being able to hang more tools and being made with less material.

The tool hanger in accordance with the present invention has a rail and multiple hanging blocks. The rail is an elongated bar and has at least one hole. Each hanging block has a hanging body, an arm and a hook. The hanging body has a sliding slot being slidably mounted on the rail. The arm protrudes from the hanging body and has a cylinder. The hook is attached to the arm.

Other objectives, advantages and novel features of the invention will become more apparent from the following detailed description when taken in conjunction with the accompanying drawings.

### BRIEF DESCRIPTION OF THE DRAWINGS

FIG. 1 is an exploded prospective view of a first embodiment of a tool hanger in accordance with the present invention;

FIG. 2 is a prospective view of a hanging block of the tool hanger in FIG. 1;

FIG. 3 is another prospective view of the hanging block in FIG. 2;

FIG. 4 is a side view of the hanging block in FIG. 2;

FIG. 5 is an exploded prospective view of the tool hanger in FIG. 1 being used with an adapter and a wrench;

FIG. 6 is a prospective view of the tool hanger in FIG. 5 being used with an adapter and a wrench;

FIG. 7 is a side view of the hanging block in FIG. 6 being used with an adapter and a wrench;

FIG. 8 is an exploded prospective view of a second embodiment of a tool hanger in accordance with the present invention;

FIG. 9 is a prospective view of a hanging block of the tool hanger in FIG. 8;

FIG. 10 is another prospective view of the hanging block in FIG. 9;

FIG. 11 is a side view of the hanging block in FIG. 9;

FIG. 12 is an exploded prospective view of the tool hanger in FIG. 8 being used with an adapter and a wrench;

FIG. 13 is a prospective view of the tool hanger in FIG. 12 being used with an adapter and a wrench; and

FIG. 14 is a side view of the hanging block in FIG. 13 being used with an adapter and a wrench.

### DETAILED DESCRIPTION OF THE PREFERRED EMBODIMENTS

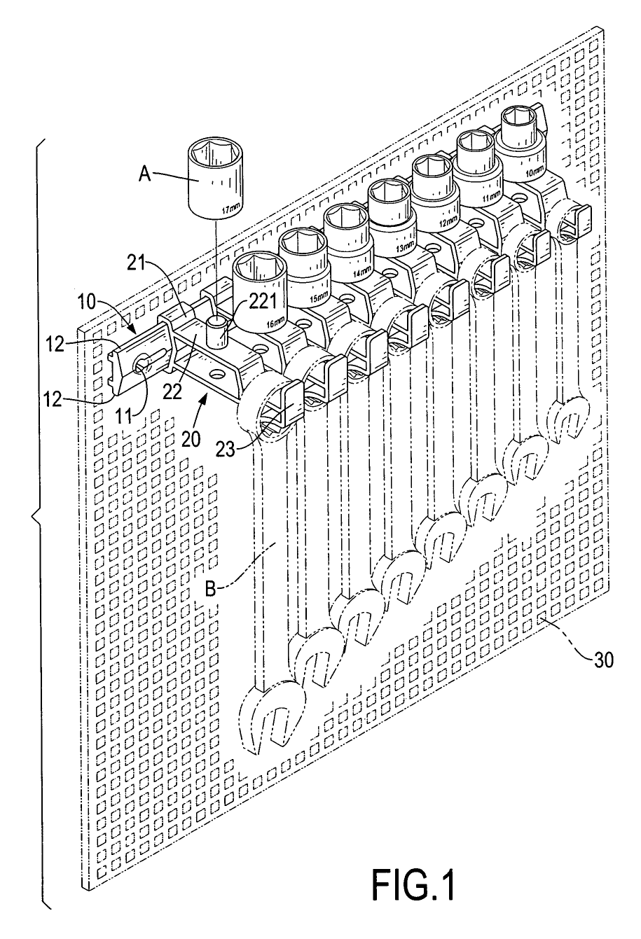

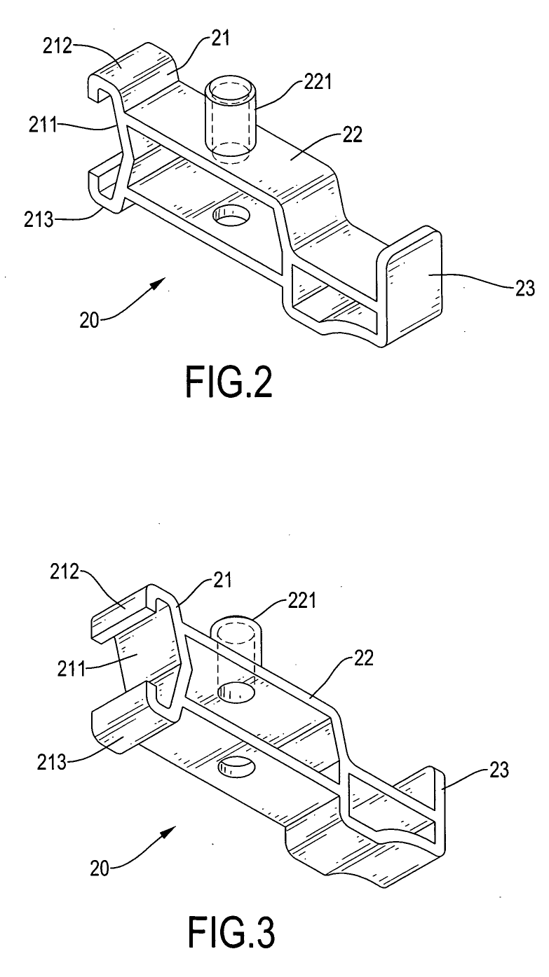

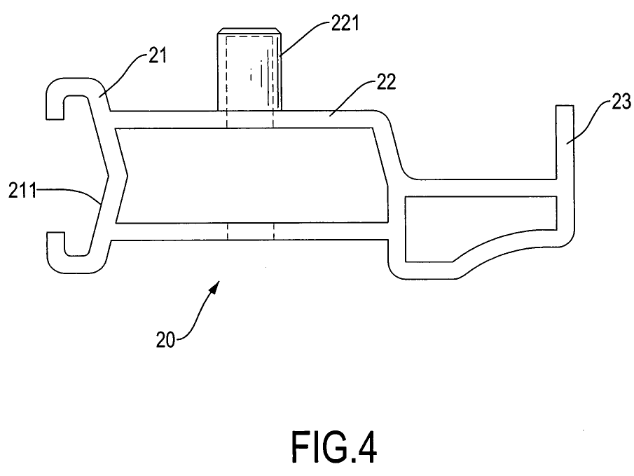

With reference to FIG. 1 to FIG. 4, a first embodiment of a tool hanger in accordance with the present invention comprises a rail (10) and multiple hanging blocks (20). The rail (10) is an elongated bar and comprises at least one hole (11). The rail (10) comprises two ends and two holes (11) being respectively defined near the ends of the rail (10). The at least one hole (11) is used to attach the rail (10) to a supporting board (30) for allowing the tool hanger to be displayed in an exhibition area or around a tool cart. Furthermore, the rail (10) comprises a top, a bottom and two edges (12) respectively formed on the top and the bottom of the rail (10).

Each hanging block (20) comprises a hanging body (21), an arm (22) and a hook (23). The hanging body (21) comprises a front and a sliding slot (211) being slidably mounted on the rail (10). The hanging body (21) may further comprise an upper mounting plate (212) and a bottom mounting plate (213). The upper mounting plate (212) is attached to the edge (12) of the top of the rail (10). The bottom mounting plate (213) is attached to the edge (12) of the bottom of the rail (10). The hanging block (20) is slidably mounted to the rail (10) by attaching the upper mounting plate (212) and the bottom mounting plate (213) respectively to the edges (12) of the rail (10).

The arm (22) is formed on and protrudes from the front of the hanging body (21) and comprises a top and a cylinder (221) protruding from the top. The top of the arm (22) may be a horizontally flat surface. The arm (22) comprises a front surface to which the hook (23) is attached. The hook (23) may protrude from the front surface of the arm (22) at a position where is lower than the top of the arm (22).

Other than the tool hanger in accordance with the first embodiment of the present invention which has two holes (11) respectively defined near the ends of the rail (10), the tool hanger may have only one hole (11) or have many holes (11) defined in the rail (10). The hole (11) or holes (11) are fit with fasteners, such as screws or bolts to attach the rail (10) onto a supporting board (30). In other words, the number of the at least one hole (11) is not specifically limited in the present invention.

With reference to FIG. 1, when using the tool hanger, fasteners are penetrated respectively through the holes (11) in the rail (10) to attach the rail (10) onto a supporting board (30) with the fasteners. A space between hanging blocks (20) can be adjusted by sliding the hanging blocks (20) on the rail (10).

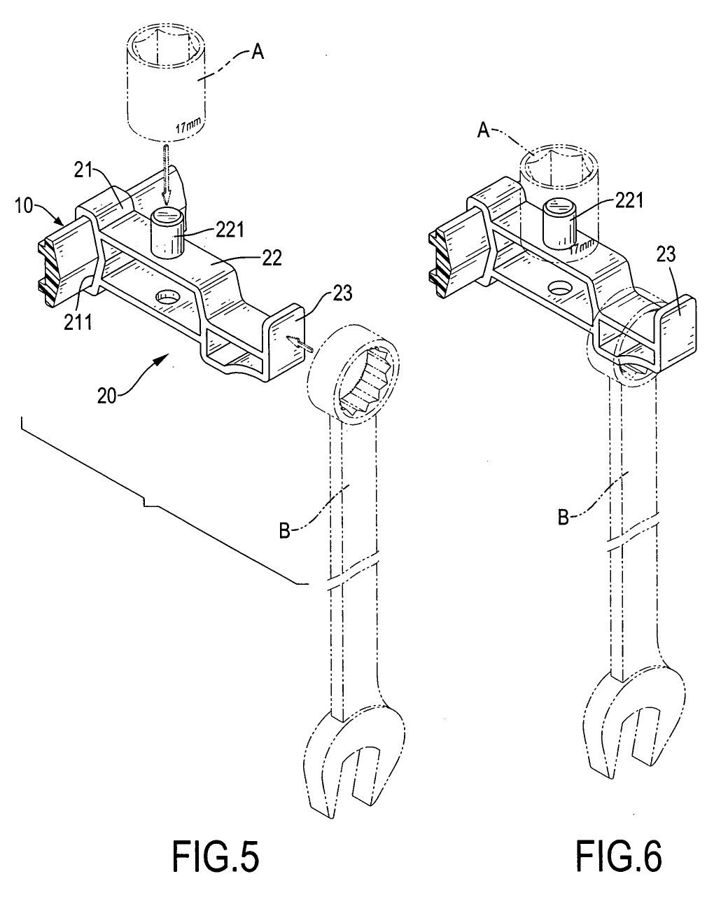

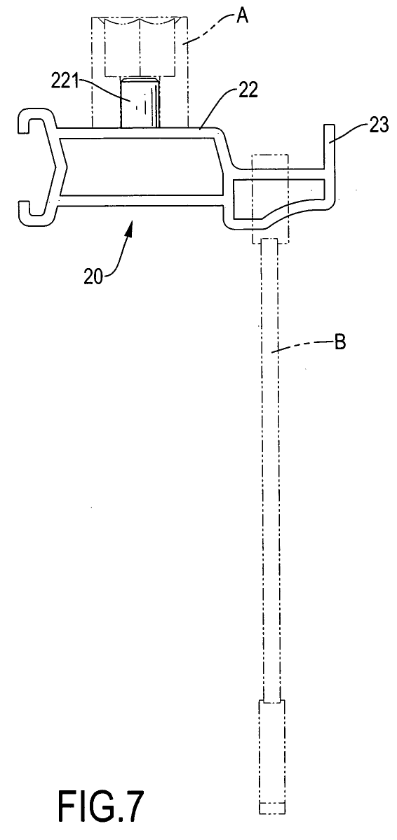

With reference to FIG. 5 to FIG. 7, the cylinder (221) holds an adapter (A) in place and the hook (23) holds a wrench (B) to hang two kinds of tools on a same hanging block (20). Therefore, each hanging block (20) of the tool hanger in accordance with the present invention can hold multiple tools and is versatile in use. Furthermore, since the hook (23) is formed on a position lower than the top of the arm (22), a wrench (B) held on the hook (23) would not block an adapter (A) having a large diameter extending out from the front surface of the arm (22).

Because each hanging block (20) can hold two adapter and wrench, the material and cost for manufacturing a tool hanger that has a capability of holding a same amount of tools as a conventional one can be reduced.

In an alternative embodiment, the hook (23) may be attached to an area of the arm (22) other than the front surface, and multiple hooks (23) may be formed on the arm (22).

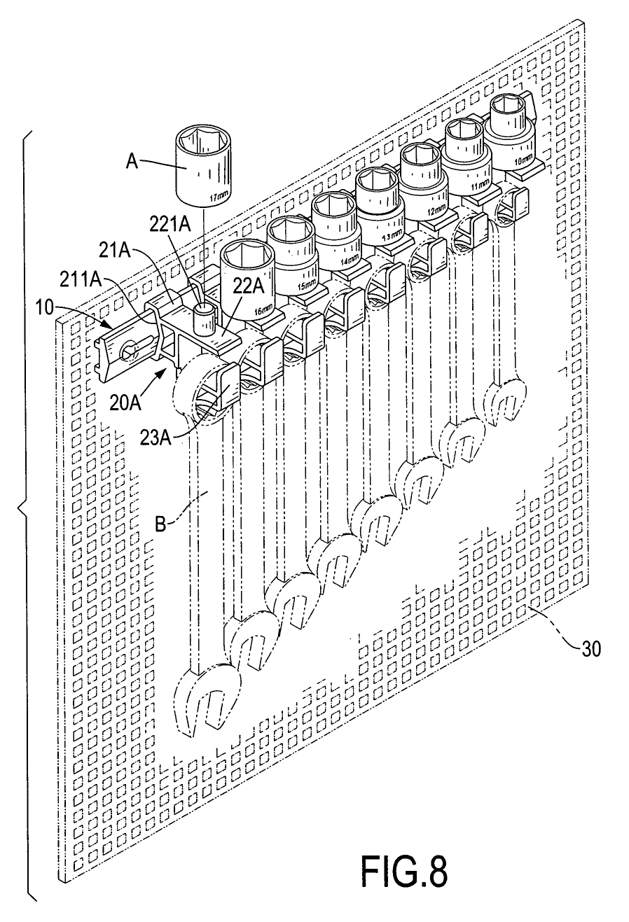

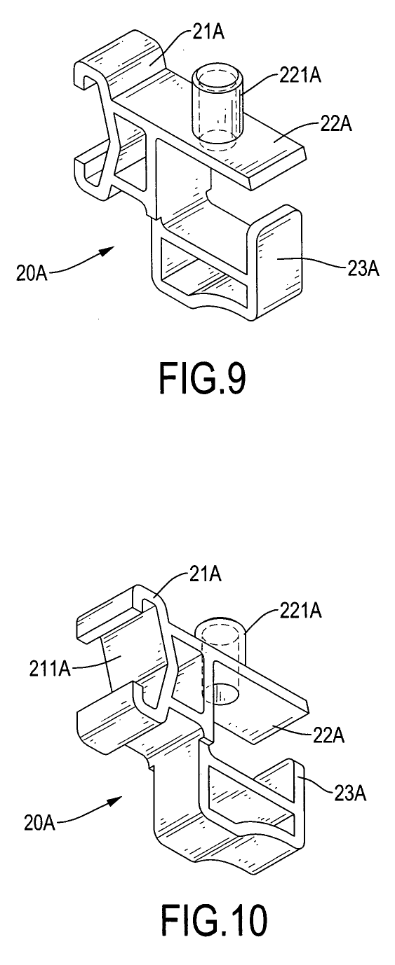

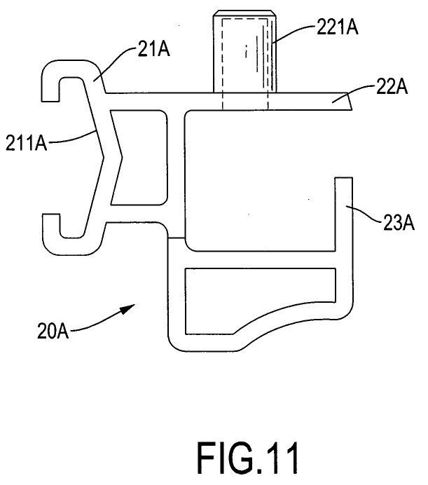

A second embodiment of the present invention is shown in FIGS. 8 to 11. With reference to FIG. 8 to FIG. 11, the second embodiment differs from the first embodiment in the shapes of the hanging blocks (20)(20A). In the second embodiment, the hanging block (20A) comprises a hanging body (21A), an arm (22A) and a hook (23A). The hanging body (21A) comprises a front and a sliding slot (211A) being slidably mounted on the rail (10) and having an upper mounting plate (212A) and a bottom mounting plate (213A).

The arm (22A) is formed on and protrudes from the front of the hanging body (21A) and comprises a top, a bottom surface and a cylinder (221A) protruding from the top. The top is a horizontally flat surface. The hook (23A) is attached to the bottom surface of the arm (22A) and is positioned lower than the top of the arm (22A).

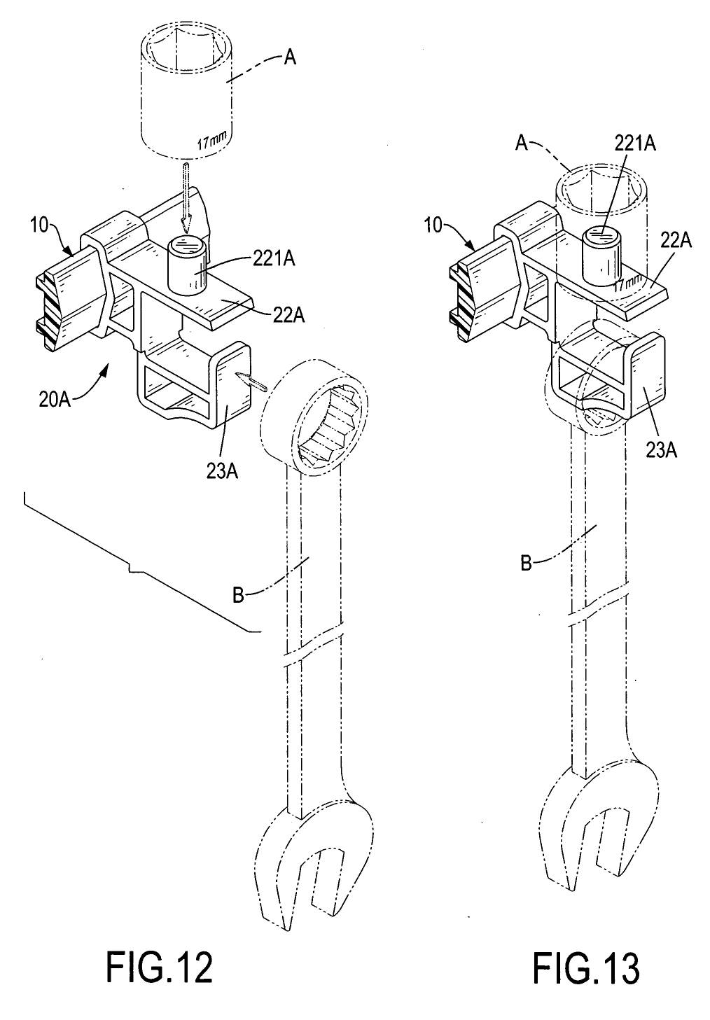

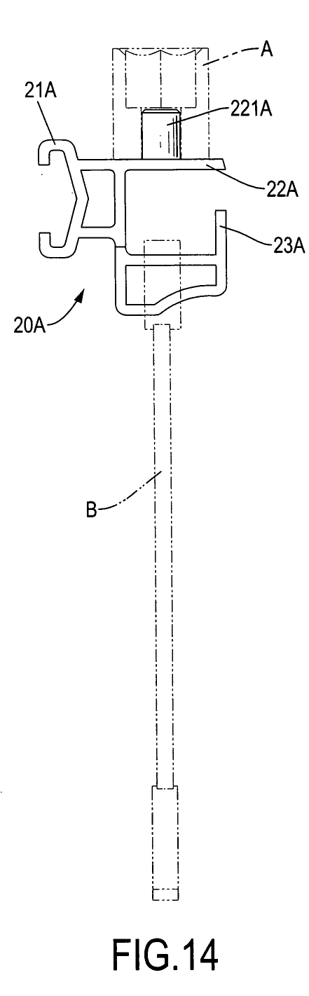

With reference to FIGS. 8 and 12 to 14, in use, the rail (10) is attached to a supporting board (30) with fasteners and the cylinder (221A) and the hook (23A) of the hanging block (20A) hold an adapter (A) and a wrench (B), respectively. Thus, multiple tools are simultaneously held on a single hanging block (20A). The tool hangers in accordance with the first and second embodiments are used in similar ways. In addition, the tool hanger in accordance with the second embodiment also provides functions of material saving and ease-recognition of diameter levels of the adapters.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tool hanger comprising
a rail comprising at least one hole; and
multiple hanging blocks slidably mounted on the rail and each comprising
a hanging body comprising
a front; and
a sliding slot being slidably mounted on the rail;
an arm being formed on and protruding from the front of the hanging body and comprising
a top; and
a cylinder protruding from the top; and
a hook being attached to the arm.

2. The tool hanger as claimed in claim 1, wherein
the hook of each hanging block is positioned at a position lower than the top of the arm of the hanging block.

3. The tool hanger as claimed in claim 2, wherein
the arm of each hanging block further comprises a front surface; and
the hook of each hanging block is attached to the front surface of the arm of the hanging block.

4. The tool hanger as claimed in claim 2, wherein
the arm of each hanging block comprises a bottom surface; and
the hook of each hanging block is attached to the bottom surface of the arm of the hanging block.

5. The tool hanger as claimed in claim 1, wherein
the rail comprises
two ends;
a top;
a bottom; and
two edges respectively formed on the top and the bottom of the rail; two holes are respectively defined near the ends of the rail; and each hanging body further comprises
an upper mounting plate being attached to the edge of the top of the rail; and
a bottom mounting plate being attached to the edge of the bottom of the rail.
